(19) United States
(12) Patent Application Publication
(10) Pub. No.: US 2010/0045229 A1
(43) Pub. Date: Feb. 25, 2010

(54) GAIN EQUALIZATION DEVICE FOR MOTOR CONTROL

(75) Inventor: HSIN-YEN CHAO, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: FOXNUM TECHNOLOGY CO., LTD., Tucheng City (TW)

(21) Appl. No.: 12/262,172

(22) Filed: Oct. 30, 2008

(30) Foreign Application Priority Data
Aug. 25, 2008 (CN) 200810304166.7

(51) Int. Cl. H02P 23/14

(52) U.S. Cl. 318/767

(57) ABSTRACT

A gain equalization device for an AC motor control includes two detection devices, a control process unit, a storage and two multipliers. Each detection device includes a current detector and an A/D converter. The current detectors are configured to detect the respective currents of two phases of an inverter circuit. Current feedback values are detected by the current detectors and converted into the digital signals by the A/D converters. The control process unit is configured to generate a compensation value to adjust the gain unbalance between gains of the detection devices. The storage is configured to store the compensation value. The multipliers are configured to compensate for an actual gain unbalance based on the compensation value stored in the storage and the current feedback values detected by the current detectors.

### BACKGROUND

1. Field of the Invention

The invention generally relates to gain equalization devices and, particularly, to a gain equalization device for an AC motor control.

2. Description of Related Art

In electronics, a gain is a measure of the ability of a circuit to increase the power or amplitude of a signal. A conventional gain equalization device is normally mounted to a three-phase AC motor, and includes first and second current detectors, and first and second A/D converters. The first and second current detectors are used to detect the respective currents of two phases and thereby perform feedback control for the two phases. If a difference occurs between the gains of the current detectors and A/D converters, a torque ripple will occur, resulting in unstable rotation of the AC motor.

With the conventional technology, in order to compensate for the gain unbalance in the current detectors and the A/D converters of the gain equalization device, the gain equalization device stores, in a storage device, a compensation value. By multiplying the detected current value of one of the detected phases by this compensation value, the current feedback gains for both phases are equalized. However, the compensation value is invariant and can not be adjusted to meet the change of the environmental conditions. A difference in the gains may still occur between the current detectors and the A/D converters of the gain equalization device when the condition (for example, temperature) of the environment is changed, even if one of the gains is compensated by the compensation value.

What is needed, therefore, is a gain equalization device for an AC motor control which can overcome the above problems.

### BRIEF DESCRIPTION OF THE DRAWINGS

FIG. 1 is a block diagram illustrating a gain equalization device in accordance with a first embodiment of the present invention.

FIG. 2 is a block diagram illustrating a gain equalization device in accordance with a second embodiment of the present invention.

### DETAILED DESCRIPTION OF THE EMBODIMENTS

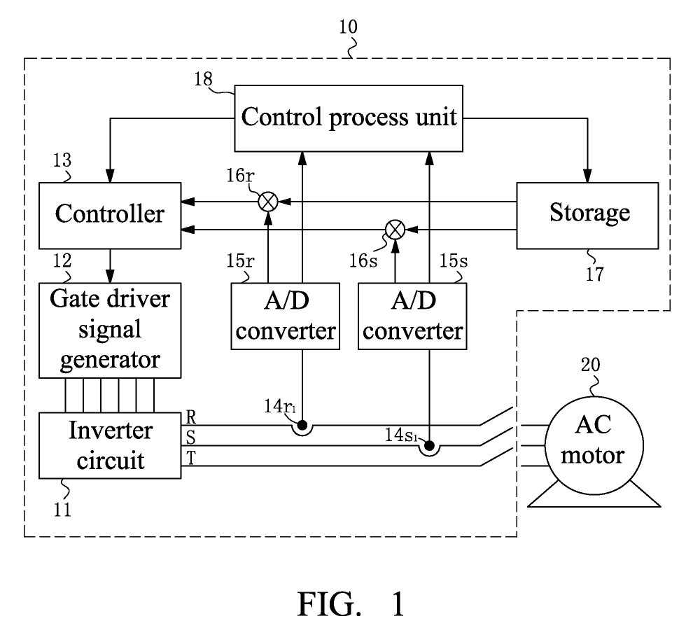

Referring to FIG. 1, a gain equalization device 10 for an AC motor control in accordance with a first embodiment of the present invention is shown. The gain equalization device 10 includes an inverter circuit 11, a gate driver signal generator 12 connected with the inverter circuit 11, a controller 13 connected with the gate driver signal generator 12, two detection devices, two multipliers 16r and 16s, a storage 17 and a control process unit 18 connected with the controller 13 and the storage 17. Each detection device includes a current detector 14r1 (14s1) and an A/D converter 15r (15s). The current detectors 14r1, 14s1 of the detection devices are configured to detect the respective currents of two phases of a motor to obtain the current feedback values. The current feedback values are converted into the digital signals by the respective A/D converter 15r or 15s. The current detectors 14r1 and 14s1 each are a hall current sensor.

If the gains of the detection devices are equal to each other, no compensation is needed to be performed to the gains. Here, the gains include both the gains of the current detectors and the gains of the A/D converters, which are referred to as the gains of detection devices. However, as these gains usually differ from each other, compensation is needed to adjust for gain unbalance in the detection devices, in order to equalize the gains.

The detection devices are connected to the outputs of R and S phases of the inverter circuit 11 respectively. Before the gain equalization device 10 is connected to an AC motor 20, the detection devices are used to detect the respective currents of R and S phases, when there is no current flowing through the two phases R, S of the inverter circuit 11. When a difference in gains occurs between the current detectors 14r1 and 14s1, the gains are delivered to the control process unit 18 via the A/D converters 15r and 15s. The control process unit 18 then generates a first compensation value to adjust the gain unbalance and stores the first compensation value in the storage 17.

After the gain equalization device 10 is connected to an AC motor 20, the detection devices are used to detect the respective currents of R and S phases, when the currents flow through the R and S phases are equal to each other, the AC motor 20 has a constant rotation speed. When a difference in gains occurs between the current detectors 14r1 and 14s1, the gains are delivered to the control process unit 18 via the A/D converters 15r and 15s. The control process unit 18 then generates a second compensation value to adjust the gain unbalance and stores the second compensation value in the storage 17.

The multipliers 16r, 16s are configured to compensate for the gain unbalance based on the first compensation value, the second compensation value and current feedback values, and adjust the gain unbalance of R and S phases of the AC motor in the same time when the motor 20 is at a later actual operation. At this time, the multipliers 16r, 16s generate two actual compensation values. The controller 13 performs feedback control of current according the actual compensation values from the multipliers 16r, 16s. The controller 13, in addition, receives a current torque command from the control process unit 18 and outputs a command signal to the gate driver signal generator 12. Based on the command signal, the gate driver signal generator 12 outputs a control command to control the inverter circuit 11. The control command is sent to the motor 20 through the three phases R, S, T of the inverter circuit 11 of the gain equalization device 10 to control the rotation of the motor 20.

The multipliers 16r and 16s generate the actual compensation values based on the real time current feedback values of the R and S phases of the AC motor 20 in the same time, wherein the real time current feedback values are varied in response to the change of the environmental conditions, for example, the change of the temperature of the environment. Thus, the actual compensation values of the gain equalization device 10 can be adjusted when the environmental conditions change.

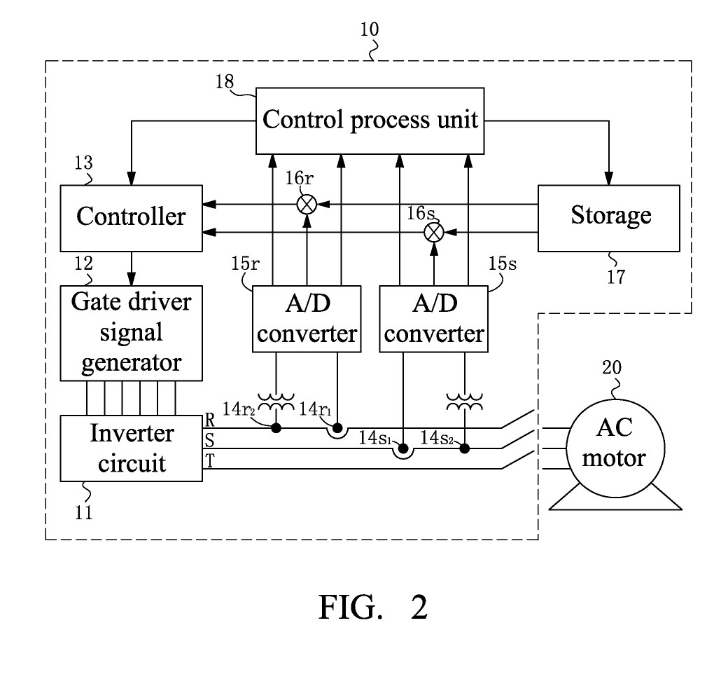

FIG. 2 illustrates a gain equalization device 10 for an AC motor control of a second embodiment of the present invention. The difference between the second embodiment over the first embodiment is that in the second embodiment, the gain equalization device 10 further includes voltage detectors 14r2, 14s2. The voltage detectors 14r2 and 14s2 are configured to detect the respective voltages of the two phases R, S of the inverter circuit 11. The voltage feedback values that are detected by the voltage detectors 14r2 and 14s2 are converted into the digital signals by the A/D converters 15r and 15s. The gain equalization device 10 can control an AC motor according to the current feedback values and the voltage feedback values, without the necessity of an encoder.

It is to be understood that the above-described embodiments are intended to illustrate rather than limit the invention. Variations may be made to the embodiments without departing from the spirit of the invention as claimed. The above-described embodiments illustrate the scope of the invention but do not restrict the scope of the invention.

What is claimed is:

1. A gain equalization device for an AC motor control, comprising:
an inverter circuit configured to send a control command to the AC motor through R, S, T phases;
two detection devices each comprising a current detector and an A/D converter, the current detectors configured to detect the respective currents of two of the R, S, or T phases to obtain current feedback values, the current feedback values being converted into the digital signals by the respective A/D converters;
a control process unit configured to generate at least a compensation value in response to a gain unbalance between gains of the two detection devices;
a storage configured to store the compensation value for compensating for the gain unbalance;
two multipliers configured to compensate for the gain unbalance based on the at least a compensation value stored in the storage and the current feedback values detected by the current detectors and generate two actual compensation values which are sent to the output circuit.

2. The gain equalization device as claimed in claim 1, wherein each detection device further comprises a voltage detector, the voltage detectors are configured to detect the respective voltages of the two of the R, S, or T phases to obtain the voltage feedback values, and the voltage feedback values are converted into the digital signals by the respective A/D converter.

3. The gain equalization device as claimed in claim 1, wherein the at least a compensation value is obtained when the detection devices are used to detect the respective currents of R and S phases of the AC motor when there is no current flowing through the R, S phases, and the gains of the detection devices are delivered to the control process unit via the A/D converters; the at least a compensation value is generated by the control process unit in response to the gain unbalance between the gains.

4. The gain equalization device as claimed in claim 3, an additional compensation is obtained when the detection devices are used to detect the respective currents of R and S phases of the AC motor when there are two currents of same value flow through the R and S phases of the AC motor, the two additional gains of the two detection devices being delivered to the control process unit via the A/D converters, the control process unit generating an additional compensation data in response to a gain unbalance between the two additional gains.

5. The gain equalization device as claimed in claim 4, wherein each multiplier is configured to compensate for an actual gain unbalance based on the at least one compensation value, the additional compensation value and a corresponding current feedback value.
